(19) United States
(12) Patent Application Publication
(10) Pub. No.: US 2012/0186023 A1
(43) Pub. Date: Jul. 26, 2012

(54) Infant breast feeding and support apparatus

(76) Inventor: Jana Braxton, Crownsville, MD (US)

(21) Appl. No.: 12/929,440

(22) Filed: Jan. 25, 2011

(51) Int. Cl. A47C 20/02; B68G 7/00; B68G 5/00

(52) U.S. Cl. 5/655; 5/652; 29/91

(57) ABSTRACT

A cushion device that can be securely attached to a body of a user to, for example, aid in supporting a baby during feeding, and provide support of the neck, elbows, forearms and wrists of a wearer while engaging in an activity such as breast feeding. The cushion device supports the neck and back, and helps to hold the neck and back in an orthopedically correct position. The cushion device also relieves muscle stress associated with holding a baby by enabling the baby to be supported by the cushion. The cushion device is shaped to conform to the user's body and can be adjusted to have a fit of desired tightness so that the cushion device remains stably and securely in place on the wearer, the neck and back support of the cushion is enhanced, and the cushion device fits comfortably on the wearer.

### FIELD OF THE INVENTION

Embodiments described herein relate generally to breast feeding, support apparatuses, and more specifically, a cushion device designed to support a baby's head and body and a mother's and father's back and neck while breast feeding or bottle feeding.

### BACKGROUND OF THE INVENTION

Breast feeding an infant provides benefits to both the infant and the nursing mother. The mother's milk contains substances that the infant needs to develop a healthy resistance to sickness and disease, as well as a naturally balanced diet of fats and proteins that the infant needs for healthy physical development. The nursing process itself provides a time for mothers to bond with their children, thereby enhancing the emotional well-being of both the infant and the mother. Nursing also benefits the mother by stimulating the pituitary glands to release oxytocin which causes the uterus to stop bleeding and begin to contract.

Feeding a baby, whether by nursing or bottle-feeding, necessitates that the mother support the infant, usually at a level near the waist or chest. In a typical position for holding a baby while feeding, the mother's head is bent forward to look at the infant. The shoulders are hunched forward. The arm muscles and anterior chest muscles contract to support the infant. The specific muscles involved in this postural stress position are the trapezius, pectoralis, levator scapulae, rhomboids, deltoids, rotator cuff group (to a lesser degree), erector sinae (from the mid-back to the base of the skull), and the splenius group (in the neck). Overcontraction of these muscles puts extra stress on the spinal vertebrae to which the muscles are attached, and can lead to spinal misalignments (subluxations).

Additionally, prolonged muscular contraction in this position (i.e., head forward, shoulders rounded and upper back bent forward) places extra stress on the corresponding muscle tendons which, if experienced frequently over a period of time, can lead to tendonitis, as well as to a generalized inflammation of the soft tissue called myofibrositis or myofascitis. More generally, the muscle stress arising from holding a baby during feeding often results in headache and/or muscle pain felt in the neck, shoulders, back, arms and/or wrists. Even if the muscle stress does not produce a degenerative physical condition, the physical discomfort may cause the mother to support the baby in an awkward position that prevents the baby from feeding properly.

The muscle stress is particularly distressing for a nursing mother. Since a mother may nurse up to fifteen (15) times per day, the mother is faced with the prospect of frequently experiencing the muscle stress associated with supporting the baby during nursing. Further, for a period after birth, the mother's body is recovering from the stress of the birth and can endure physical exertion to a lesser extent than would otherwise be normal. The care of a newborn infant typically also leaves little time for sleep; without sleep, the mother becomes exhausted and more susceptible to muscle fatigue. These problems are exacerbated by the fact that the mother must out of necessity physically exert herself many times a day to pick up and put down the baby.

Prior to now, when a mother breast fed her baby she had to cradle the baby in her arms to hold the baby's head at the required height to align with her breast. Holding a baby like this for any length of time puts considerable stress on the mother's body.

There are various conventional devices such as pillows that have been used to help alleviate the muscle stress typically experienced during feeding of a baby. Pillows, however, generally do not provide adequate support. For instance, while some pillows support the baby and others support the arms of the mother, none provide adequate support of both the baby and the mother's arms, while simultaneously supporting the mother's neck and back. Additionally, none of the conventional pillows cushion the neck and back of the mother or provide back lumbar support for the mother. Such support characteristics are highly desirable to alleviate the muscle stress experienced by the neck and back while supporting a baby. Nursing slings have also been designed to hold a baby with the weight of the sling pulling on the mother's neck and upper back. Slings, however, put considerable stress on the mother's neck and back. Slings also tend to pull the baby's head and body toward the mother, which restricts the baby's freedom of movement. Because of this, a sling is not suitable for bottle feeding. The above-described problems are equally applicable to a baby's father, or whomever else may occasionally feed a baby.

### BRIEF SUMMARY OF THE INVENTION

Embodiments described herein relate to a cushion device that can be securely attached to a body of a user to aid in supporting a baby during feeding, and provide support of the neck, back, elbows, forearms and wrists of a wearer while engaging in an activity such as breast feeding or bottle feeding. The cushion device supports the neck and back of the user, and helps to hold the neck and back of the user in an orthopedically correct position. The cushion device also relieves muscle stress associated with holding a baby by enabling the baby to be supported by the cushion device. The cushion device is shaped to conform to the user's body and can be adjusted to have a fit of desired tightness so that the cushion device remains stably and securely in place on the wearer, the neck and back support of the cushion is enhanced, and the cushion device fits comfortably on the wearer. The cushion device reduces the muscle fatigue that a mother, father or other person typically experiences when feeding an infant.

### BRIEF DESCRIPTION OF THE DRAWINGS

FIG. 1 is an illustration of an embodiment described herein.

FIG. 2 is another illustration of the embodiment described herein.

FIG. 3 is another illustration of the embodiment described herein.

FIG. 4 is another illustration of the embodiment described herein.

### DETAILED DESCRIPTION OF THE INVENTION

Embodiments discussed herein provide cushion devices designed to support a baby's head and body and a wearer's back and neck while breast feeding or bottle feeding. In the following detailed description, reference is made to the accompanying drawings which form a part hereof, and in which is shown by way of illustration specific embodiments that may be practiced. These embodiments are described in sufficient detail to enable those of ordinary skill in the art to make and use them, and it is to be understood that structural and logical changes may be made to the embodiments disclosed.

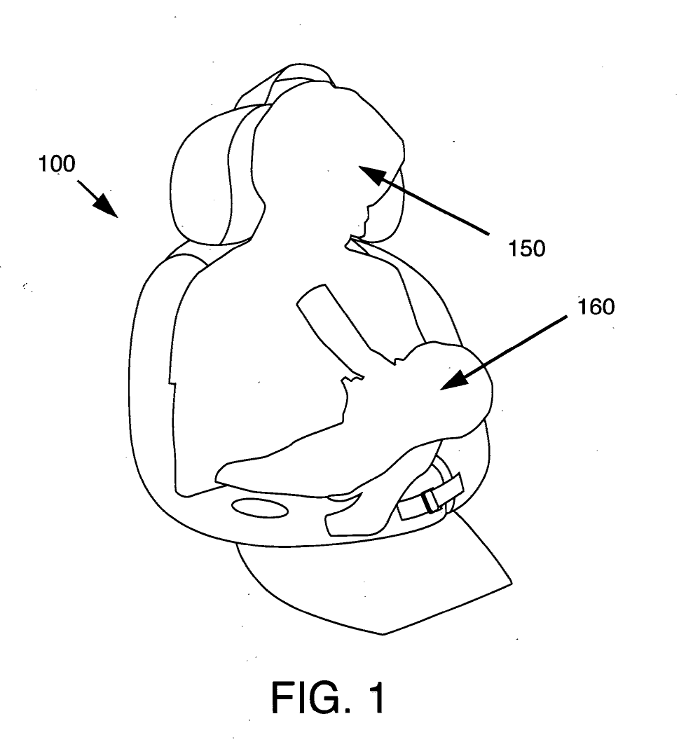

Generally, as illustrated in FIGS. 1-4, cushion device 100 is worn around the waist and midsection of a user 150, and behind the head of the user 150. The cushion device 100 has two arms 120 which are normally opposed to each other to define a region so that when worn, the cushion device substantially completely surrounds the waist of the user 150. The region can be varied in size by moving the position of the arms with respect to each other. The cushion device 100 is made of a firm, yet resilient material. Variance of the size of the region in which the user's waist fits, the firmness and resilience of the material of which the cushion is made, and the height of the back portion of the cushion combine to enable the cushion device to fit snugly about the waist, the snug fit providing support of the user and helping to keep the cushion device in place on the user. A fastening mechanism can be attached to the arms of the cushion device and used to make the cushion device fit even more snugly about the waist so that the cushion device is held more securely and stably to the body. The cushion device is made of a lightweight material so that the cushion device can be easily lifted and/or transported by the user. Cushion device 100 can be adjusted to accommodate people of different sizes or to enclose a particular wearer more or less tightly.

As a nursing device, the cushion device 100 is unique in that it combines a large number of features that previously have not all been present in a cushion device. Perhaps most importantly, the cushion device provides a neck and back support system that provides lumbar support for the back, cushions the neck, and helps to position a mother in an ergonomically correct posture for nursing, thereby reducing the muscle fatigue that the mother typically experiences when leaning over to cradle and feed an infant. The beneficial neck and back support characteristics arise from the thickness and height of the neck and back support portion, the firm yet resilient material of which the cushion device is made and the adjustability of the cushion device which enables the neck and back support portion to be “firmed up” around the waist, lower back, neck and head.

Cushion device 100 is also useful in minimizing muscle strain for mothers who gave birth by Cesarean-section. The adjustability of the cushion device allows the mother to adjust the fit of the cushion device for maximum comfort and stability. Thus, as a mother experiences a post-partum reduction in waist size, the mother can adjust the size of the opening accordingly. This adjustability is also particularly important to mothers who are recovering from a Cesarean-section delivery, the adjustability enabling these mothers to wear the cushion device relatively loosely so that the wounds from surgery are not aggravated. The softness of the material with which the cushion device is made also helps in this regard. Further, since the discontinuity in the cushion device is formed on the side, the cushion device is adjustable without sacrificing any of the neck and back support characteristics of the cushion device.

In the embodiments shown in FIGS. 1-4, cushion device 100 comprises of a cushion body 140 having a medial region 145 and two opposing arms 120 with ends extending from the medial region 145 to define an inner well region, a head portion 115, and a back portion 105. Generally, cushion body 140 may be defined in terms of a medial region 145 and two opposing arms 120, respectively. The cushion body 140 is sized and configured to permit the medial region 145 to rest on a user's lap, with the ends of the opposing arms 120 being generally adjacent to the user's waist. The arms 120 are sized and configured to assist in supporting a baby 160 when lying on the cushion body 140 while the ends of the arms 120 are generally adjacent to the user's waist. The medial region 145 may have an average radius of curvature that permits it to conform to the shape of a person's torso while still having flexibility enough so that it may fit around individuals of various sizes. Hence, cushion device 100 may be used to facilitate the feeding of a baby by placing the baby 160 onto the cushion body 140, with the baby's bottom or hip resting on the medial region 145 and the upper body being supported by one or more of the arms 120. Cushion device 100 may also have a handle 110 to help transport the cushion device 100. Handle 110 is a helpful aid in carrying and picking up cushion device 100.

The lap surface 155 of the medial region 145 enables the cushion device 100 to rest comfortably and stably in the lap when the cushion device 100 is worn while sitting. Since the lap surface 155 is soft, flexible and contouring, contact with the lap does not force the cushion device 100 into an awkward position or cause the cushion device 100 to rock when the cushion device 100 is worn while sitting. Further, the lap surface 155 contours against the lap without producing uncomfortable pressure on any part of the legs.

The support surface 165 of the medial region 145 provides comfortable and stable support for both the person wearing the cushion device 100 and the baby being held by that person. For example, as shown in FIG. 1, while nursing, the woman 150 can support the baby 160 on the support surface 165 (not shown) of the cushion device 100.

The arms 120 may be constructed so that they are generally curved to form slightly sloping surfaces down to medial region 145. In this way, the slight slope elevates the baby's back and head for easy nursing as illustrated generally in FIG. 1. Further, the arms 120 may be used to help hold the user's arm when nursing or feeding the baby. When nursing or feeding a baby, medial region 145 provides support for the baby's bottom or hip, and the sloping surfaces of the opposite arm 120 help hold the baby in place so that the baby will not slide or move around during feeding. Hence, as shown in FIG. 1, a user may nurse a baby while sitting upright in an ergonomically correct position, with the user's arms resting on arms 120. Further, the baby's mouth is properly positioned in front of the mother's breast so that the mother may comfortably nurse the baby. The sloping surfaces of the cushion body properly orient the baby's body while also holding the baby in the proper position.

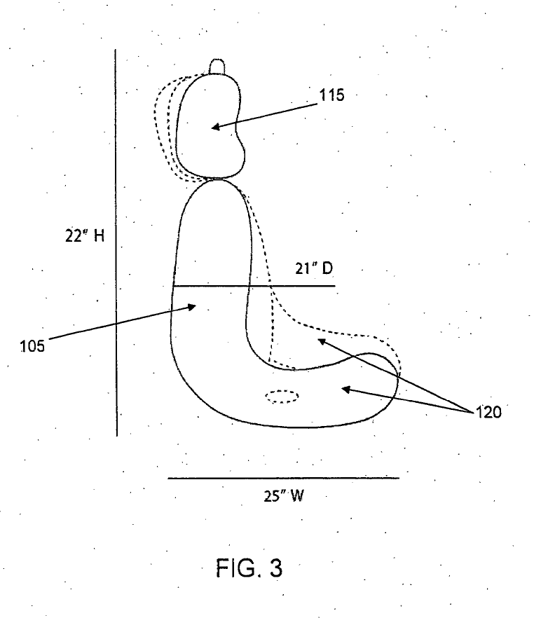

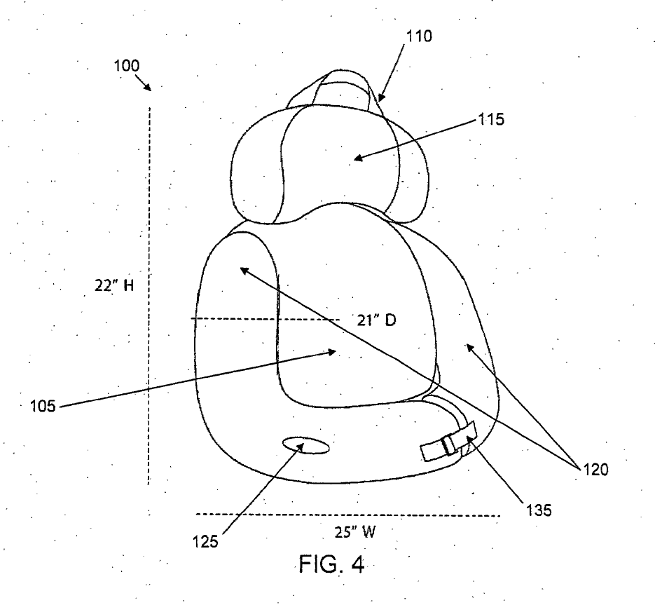

The dimensions of the cushion device 100, as illustrated in FIGS. 3 and 4, may be selected so that the cushion device 100 may conveniently fit on the user's lap while also providing the proper position for the baby, such as when feeding or holding the baby. It is important to appreciate, however, that cushion device 100 is not confined to any specific set of dimensions. In practice, cushion devices 100 can have a number of different sizes. The particular size of the cushion device 100 can vary with the use for which the cushion device is intended as well as the size of the person for whom the cushion device is intended. In view of this, the dimensions of the cushion device 100 are described primarily as they relate to the functional attributes of the cushion device 100; the use of specific dimensions is intended merely to be illustrative and not as a limitation of the size or proportions of the cushion device 100.

For example, the height of the medial region 145 is established so that, when the cushion device 100 is used to support a baby during feeding, the baby is supported at a height that enables the baby to nurse comfortably without need for the woman to lift the baby toward the breast. It is also desirable to allow sufficient room for the person feeding the baby to rest their forearms on the cushion device 100 to cradle the baby. The height of the arms 120 of the cushion device 100 are chosen so that the elbows and forearms of the wearer of the cushion device 100, when held naturally at the sides of the body during feeding of a baby, are supported on the cushion device 100 without necessity for awkward positioning. The width of the arms 120 is chosen to provide adequate surface area to support the elbows and forearms. The height of the back portion 105 of the cushion device 100 is specified so that the back portion 105 provides support that reduces muscle stress in the back, provides adequate area for cushioning the back against the back of a chair, and causes the wearer of the cushion device to sit in an orthopedically correct manner. The width of the back portion 105 is also chosen to provide adequate support, cushioning and positioning of the back. Typically, the height and width of the back portion 105 vary, though either can be constant. The height of the head portion 115 of the cushion device 100 is specified so that the head portion 115 provides sufficient support such that the muscle stress in the neck is reduced, adequate area for cushioning the neck is provided, and the wearer of the cushion device is forced to sit in an orthopedically correct manner. The width of the head portion 115 is also chosen to provide adequate support, cushioning and positioning of the neck.

An adjustment strap 135 can be used to attach the arms 120 of the cushion device 100 to each other. The adjustment strap 135 helps to ensure that the cushion device 100 remains stably in position about the waist. However, in other embodiments of the invention, the adjustment strap 135 may not be present. The arms 120 of the cushion device 100 can be made in a fashion that enables the cushion device 100 to remain in position about the waist, under many circumstances, even without the adjustment strap 135.

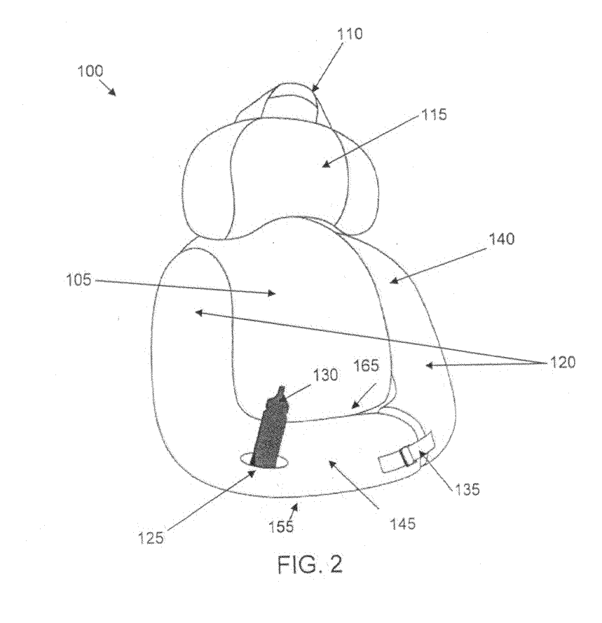

A pocket 125 is formed in the medial region 145 of the cushion device 100. The pocket 125 can be used to hold any of a number of items. For instance, in FIG. 2, a baby bottle 130 is shown inserted into the pocket 125. The pocket 125 can also be used to hold other items such as a cordless telephone, towel, small toy or a book. Additionally, cushion device 100 can be used for many purposes other than to aid in nursing a baby; in these applications, the pocket formed on the cushion device can hold many other types of objects such as, for example, a book, eyeglasses, pencils, a calculator, or a cordless telephone.

To facilitate manufacturing, cushion device 100 is made of a resilient material so that the baby and/or the arms of the person wearing the cushion device 100 are cushioned. At the same time, the material is sufficiently firm so that the baby and/or the arms are held in a stable position during nursing.

Cushion device 100 can be constructed of a fill material that is covered by a fabric outer cover. The outer cover may be constructed of a top piece, a middle piece and a bottom piece. These pieces may be sewn together along seam lines to enclose the fill material. Use of the middle piece also provides cushion device 100 with greater flexibility so that arms 120 may be manipulated without causing buckling of the cushion body 140. Conveniently, arms 120 and medial region 145 may be a continuation of the top and bottom pieces that are sewn together along the inner edges of the arms 120. However, it should be appreciated that other methods of constructing the arms and medial region may be used as well. For example, arms 120 and medial region 145 may comprise a single piece of fabric or separate pieces of fabric. In addition, medial region 145 may be constructed of a non-stretchable material while a stretchable material is used to construct arms 120 so that the arms can further separate from each other.

Examples of fill materials that may be used include resilient, compression resistant, memory foam, hypoallergenic material, such as polyester fibers, and other similar materials. The outer cover may be any type of fabric such as cotton, nylon, LYCRA®, denim, polyester, organic, and other similar materials. The fill material may be stuffed inside the cover to provide sufficient firmness so that the cushion device generally does not sag or droop when held at the medial region. This firm natures also provides sufficient firmness so that a baby is supported without significant deflection or indentation of cushion body 140. Use of a center seam is also useful in that it helps the cushion body 140 return to its original shape. After stuffing the fill material within the cover, the cover may be closed by creating an exterior seam line. However, other techniques could be used as well. For example, the preferred embodiment includes a zipper that can be used in place of an exterior seam. In this way, the cover could be removed for washing and then replaced over the fill material.

Having described specific preferred embodiments of the invention with reference to the accompanying drawings, it is to be understood that the invention is not limited to those precise embodiments, and that various changes and modifications may be effected therein by one skilled in the art without departing from the scope or the spirit of the invention as defined in the appended claims. Although the invention has been described in relation to a number of examples, in no way do those examples limit the invention.

1. A cushion device comprising:
a cushion body having a medial region and two opposing arms with ends extending from the medial region to define an inner well region;
a head portion; and
a back portion,
wherein the cushion body, the head portion and the back portion are made of a single piece of material and
the medial region comprises of a lap surface for enabling the cushion device to rest comfortably and stably in the lap of a user and a support surface for providing comfort and stability to the user and a baby held by the user.

2. The cushion device of claim 1, wherein the cushion device is a breast feeding device.

3. The cushion device of claim 1, further comprising a fastening mechanism for connecting the opposing arms.

4. The cushion device of claim 1, wherein the cushion body, the head portion and the back portion are made of a resilient material.

5. The cushion device of claim 4, wherein the resilient material comprises a lightweight material.

6. (canceled)

7. (canceled)

8. The cushion device of claim 1, wherein the lap surface contours against a lap of the user.

9. A breast feeding apparatus comprising:
a cushion portion having a medial region and two arms extending from the medial region in either direction, wherein the arms define a well region;
a head portion; and
a back portion,
wherein the cushion body, the head portion and the back portion are made of a single piece of material and
the medial region comprises of a lap surface for enabling the cushion device to rest comfortably and stably in the lap of a user and a support surface for providing comfort and stability to the user and a baby held by the user.

10. (canceled)
